(19) United States
(12) Patent Application Publication
(10) Pub. No.: US 2017/0120922 A1
(43) Pub. Date: May 4, 2017

(54) MAINTENANCE VEHICLE

(71) Applicant: MTD PRODUCTS INC, Valley City, OH (US)

(72) Inventors: Axel Schaedler, Olmsted Township, OH (US); Jimmy N. Eavenson, Sr., Aurora, OH (US); Peter J. Buchanan, Elyria, OH (US)

(21) Appl. No.: 15/342,239

(22) Filed: Nov. 3, 2016

Related U.S. Application Data
(60) Provisional application No. 62/250,755, filed on Nov. 4, 2015.

(51) Int. Cl. B60W 30/18; A01D 69/03; B60W 10/20; B62D 11/04; B62D 3/12; B60W 10/10; A01D 69/02; B62D 9/00

(52) U.S. Cl. CPC B60W 30/18145; A01D 69/02; A01D 69/03; B62D 9/00; B62D 11/04; B62D 3/12; B60W 10/10; B60W 10/20; A01D 2101/00

(57) ABSTRACT

A maintenance vehicle having a frame supported by a pair of traction wheels and at least one steered wheel. The maintenance vehicle also includes a steering assembly having a pair of control levers for directly controlling a pair of transmissions that drive the traction wheels, a pair of sensors for measuring a characteristic of each transmission, the sensors being operatively connected to a system controller which generates an output signal to a steering controller for independently controlling the steering of the steered wheel(s).

### CROSS-REFERENCE TO RELATED APPLICATIONS

This application claims the benefit of U.S. Provisional Application No. 62/250,755, filed Nov. 4, 2015, the entire disclosure of which is hereby incorporated herein by reference.

### FIELD OF THE INVENTION

The present invention relates to lawn, garden, and golf course maintenance vehicles.

### BACKGROUND OF THE INVENTION

Maintenance vehicles, such as lawn maintenance vehicles in the form of lawn mowers or golf course maintenance vehicles in the form of bunker rakes and types of vehicles, are used on sometimes rough terrain that includes hillsides, gullies, recessed sand traps, or other sloped surfaces. Many of these maintenance vehicles are steered with control levers in the form of lap bars, wherein the lap bars often directly control hydraulic actuators or electronic controllers independently driving each of a pair of traction wheels. These vehicles typically include at least one caster wheel that engages the ground, but the caster wheel(s) rotates freely and is not steered. These un-steered caster wheels can cause uneven steering or difficulty in controlling and maneuvering the maintenance vehicle. For example, when maneuvering maintenance vehicles over these rough terrains, steering becomes an issue due to slippage of the traction wheels or loss of contact between the caster wheel(s) and the ground.

### BRIEF SUMMARY OF THE INVENTION

In one aspect of the present invention, a maintenance vehicle is provided. The maintenance vehicle includes a frame and a seat attached to the seat frame. The maintenance vehicle also includes a steering mechanism, the steering mechanism including a pair of control levers operatively connected to the frame and a pair of transmissions. Each transmission is operatively connected to one of the control levers, and each of the transmissions has an output shaft that is connected to a traction wheel, wherein the pair of control levers directly control the transmissions. A first sensor is operatively connected to one of the transmissions and a second sensor is operatively connected to the other transmission, wherein each of the first and second sensors measures a characteristic of the corresponding transmission. Each of said sensors generates an output signal representing the measured characteristic. A system controller is operatively connected to the first and second sensors for receiving the first output signals therefrom. The system controller calculates an overall steered direction and generates at least one second output signal representing the overall steered direction. At least one steered wheel assembly is operatively connected to the frame, and each of the steered wheel assembly/assemblies includes at least one steered wheel. At least one second output signal from the system controller causes the steered wheel assembly to rotate the steered wheel(s) to the overall steered direction.

In another aspect of the present invention, a maintenance vehicle is provided. The maintenance vehicle includes a frame and a seat attached to said frame. The maintenance vehicle also includes a steering mechanism that includes a pair of control levers operatively connected to the frame and a pair of transmissions, wherein each transmission is operatively connected to one of the control levers. Each of the transmissions has an output shaft that is connected to a traction wheel, wherein each control lever controls operation of one of the corresponding transmissions. The maintenance vehicle also includes a pair of sensor, wherein each of the sensors measures a characteristic of one of the transmissions. Each of the sensors generates a first output signal representing the measured characteristic. A system controller is operatively connected to the sensors for receiving the first output signals therefrom. The system controller calculates an overall steered direction determined by the first output signals, and a second output signal is generated by the system controller. A steering controller is operatively connected to the system controller for receiving the second output signal therefrom. At least one steered wheel assembly is operatively connected to the steering controller. Each of the steered wheel assemblies includes at least one steered wheel, and the steering controller causes rotation of the at least one steered wheel assembly to align each of the steered wheel(s) attached thereto in said overall steered direction in response to the second output signal received from the system controller.

In a further aspect of the present invention, a method for steering a maintenance vehicle is provided. The method includes providing a frame and a seat attached to the frame. The method further includes providing a steering assembly having a pair of control levers operatively connected to a pair of transmissions, wherein each transmission has an output shaft extending therefrom to which a traction wheel is attached, and movement of each of the control levers controls the corresponding transmission. The method also includes measuring a characteristic of each of the transmissions and providing a system controller for calculating an overall steered direction based upon the measured characteristic of each of the transmissions. An output signal is generated from the system controller. The method further including steering at least one steered wheel in the overall steered direction in response to the output signal from the system controller

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1 is a perspective view of an embodiment of a maintenance vehicle;

FIG. 2A is a schematic view of one embodiment of a steering assembly of the maintenance vehicle shown in FIG. 1;

FIG. 2B is a schematic view of another embodiment of a steering assembly of the maintenance vehicle shown in FIG. 1;

FIG. 2C is a schematic view of still another embodiment of a steering assembly of the maintenance vehicle shown in FIG. 1;

FIG. 2D is a schematic view of yet another embodiment of a steering assembly of the maintenance vehicle shown in FIG. 1;

FIG. 3A is a schematic of an embodiment of a steering assembly of a maintenance vehicle having one steered wheel;

FIG. 3B is a schematic of another embodiment of a steering assembly of a maintenance vehicle having a pair of steered wheels; and

FIG. 4 is a perspective view of another embodiment of a maintenance vehicle.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

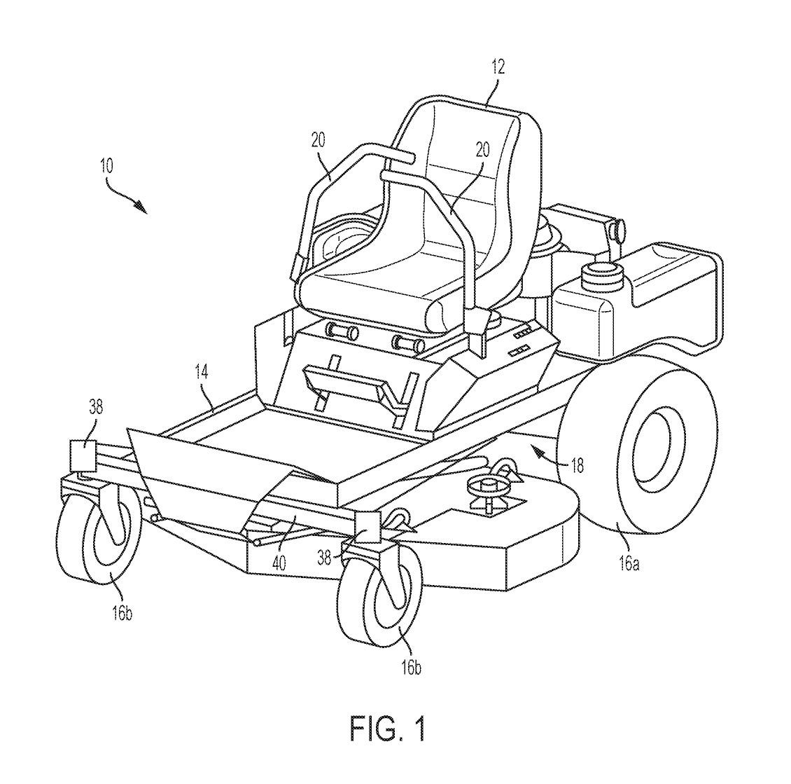

Referring to FIG. 1, an exemplary embodiment of a maintenance vehicle 10 is shown. The maintenance vehicle 10 shown in FIG. 1 is illustrated as a riding lawn mower, but it should be understood by one having ordinary skill in the art that reference to a maintenance vehicle 10 may also mean a garden tractor, a golf course manicure vehicle such as a reel mower, a sand trap/bunker maintenance vehicle, or the like. The maintenance vehicle 10 includes a seat 12 on which an operator sits during operation of the vehicle, and the seat 12 is operatively connected to a frame 14 that supports the seat 12. In other embodiments, the maintenance vehicle 10 can be a stand-on-type maintenance vehicle, wherein a platform (not shown) or the like is operatively connected to the frame 14 to allow the operator to stand on the platform during operation of the maintenance vehicle 10. The maintenance vehicle 10 also includes a plurality of wheels 16, which includes a pair of traction wheels 16a and at least one steered wheel 16b that is part of a steered wheel assembly 17 that is connected to the frame 14. The operator generally controls the direction and rotational speed of the traction wheels 16a by way of a steering assembly 18, and the steered wheel(s) 16b is indirectly controlled through at least one controller or actuator that determines the steered orientation of the steered wheel(s) 16b in response to the rotational speed and the rotational direction of each of the traction wheels 16a.

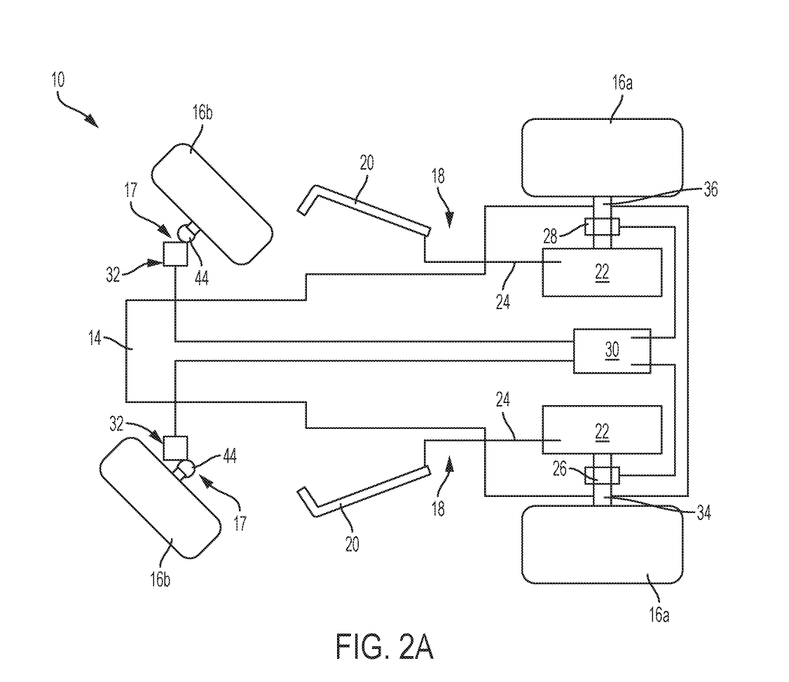

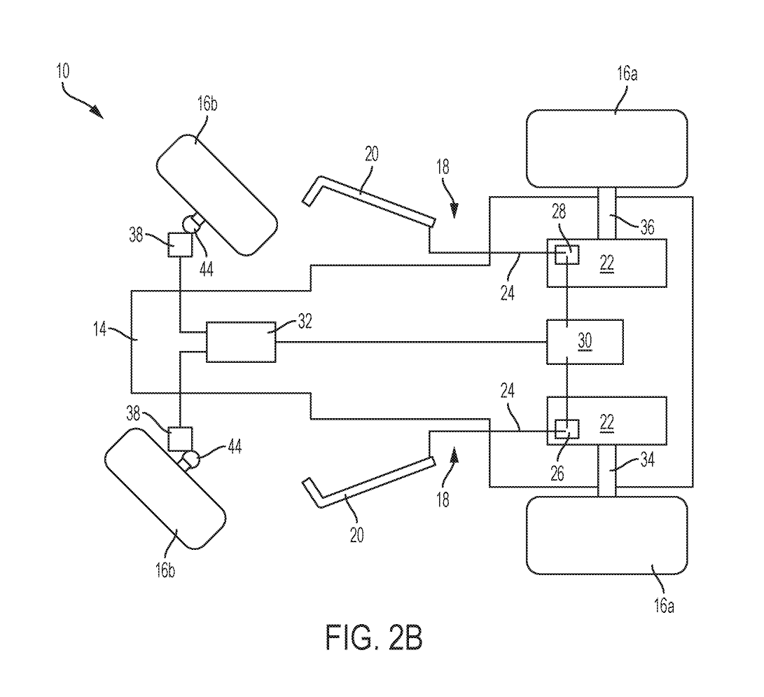

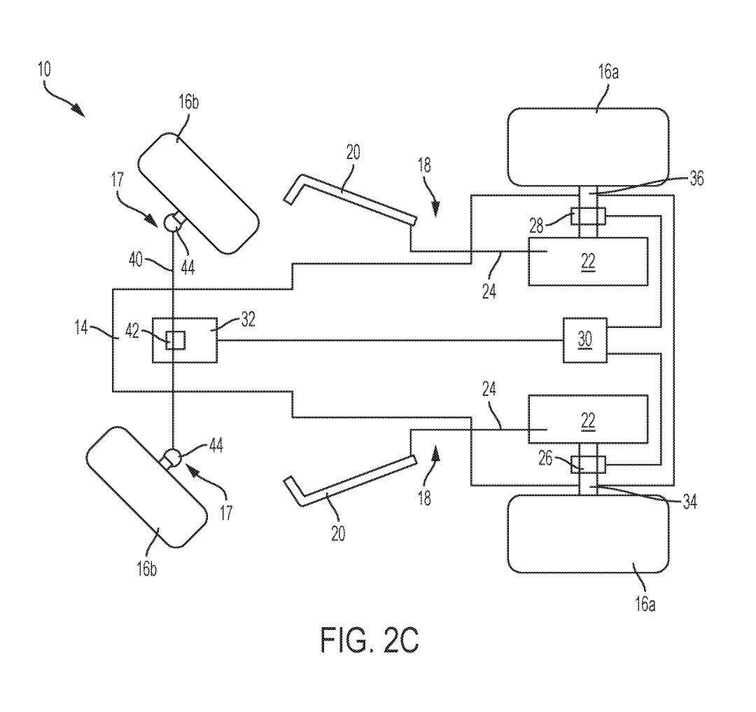

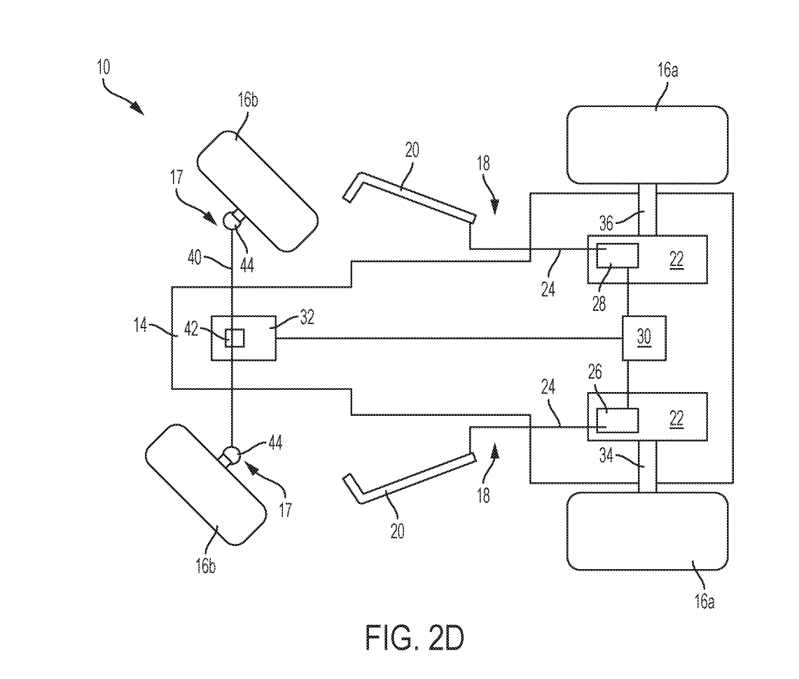

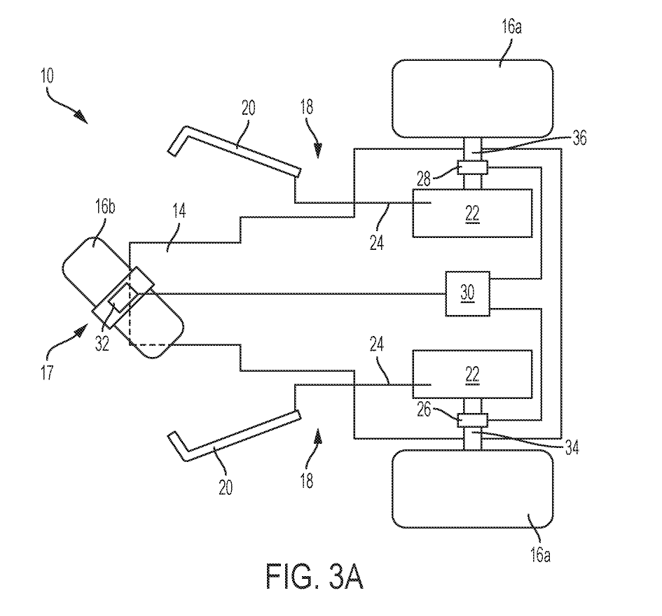

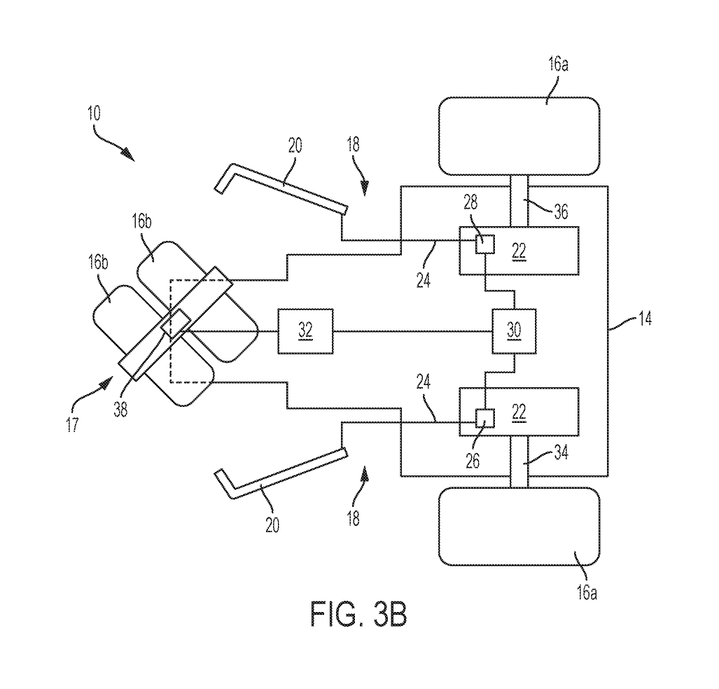

In each of the embodiments of the maintenance vehicle 10 described below, the maintenance vehicle 10 includes a steering assembly 18 which is operable by the operator to control the speed and direction of the maintenance vehicle 10. In an embodiment, the steering assembly 18 includes at least one control lever 20 and a pair of hydraulic actuators or electronic controllers and traction motors 22. In the embodiment illustrated in FIGS. 2A-2D and 3A-3B the steering assembly 18 includes a pair of control levers 20 and a pair of corresponding hydrostatic or electric-driven transmissions 22 operatively connected to a corresponding control lever 20, wherein each transmission 22 includes an output shaft 34, 36 extending therefrom. The steering assembly 18 further includes the linkage assembly 24 that connects each control lever 20 to the corresponding transmission 22. The output shafts 34, 36 of each transmission 22 are directed outwardly from the frame 14 from opposing sides thereof. In an embodiment, the control levers 20 are formed as lap bars, as shown in FIG. 1. The control levers 20 are positioned on opposing sides of the seat 12 and are graspable and rotatable by the operator. The control levers 20 are movable in the forward and rearward directions relative to the longitudinal centerline of the maintenance vehicle 10 for controlling the direction and speed of the maintenance vehicle 10. The control levers 20 are also configured to rotate laterally outward into a neutral position to allow the operator to enter and/or exit the seat 12. In another embodiment, the maintenance vehicle 10 is controlled by only a single control lever, such as a joystick or the like. It should be understood by one having ordinary skill in the art that any number of control levers 20 can be used to control the speed and direction of the maintenance vehicle 10. In other embodiments, the maintenance vehicle 10 is controlled by a pair of foot controls that are configured to be operated by a user's feet in a manner similar to the control levers 20 shown in FIG. 1. Although different types of user-controlled steering components can be used for user steering input to the steering assembly 18, the description below will refer to only the control levers 20 as being lap bars.

The maintenance vehicle 10 further includes a first sensor 26, a second sensor 28, a system controller 30, and a steering controller 32, as shown in FIGS. 2A-2D and 3A-3B. The first and second sensors 26, 28 are configured to sense or measure at least one characteristic and to generate a first output signal. The first output signal generated by each of the first and second sensors 26, 28 is transferred to the system controller 30. The system controller 30 processes the output signal from the first and second sensors 26, 28 and transmits a second output signal to the steering controller 32. The steering controller 32, in turn, utilizes the second output signal from the system controller 30 to steer at least one steered wheel assembly 17 which correspond to the overall steered direction produced by the driven traction wheels 16a or the relative positions of the control levers 20.

In the illustrated embodiment, the pair of hydrostatic or electric-driven transmissions 22 are each operatively connected to a corresponding control lever 20, wherein each hydrostatic or electric-driven transmission 22 is configured to drive a traction wheel 16a by way of an output shaft 34, 36, as shown in FIGS. 2A-2D and 3A-3B. In some embodiments, each control lever 20 is operatively connected to the swashplate or actuator (not shown) of one of the hydrostatic or electric-driven transmissions 22 such that the control lever 20 directly controls the corresponding hydrostatic or electric-driven transmission 22. In the embodiments illustrated in FIGS. 2A-2D and 3A-3B the control levers 20 are connected to the hydrostatic or electric-driven transmissions 22 by way of a linkage assembly 24 which is included in the steering assembly 18, thereby providing direct control of the hydrostatic or electric-driven transmissions 22 by the control levers 20.

When each control lever 20 is in a neutral position—at which point the control levers 20 can be rotated laterally outward to engage a parking brake or the like—the corresponding hydrostatic or electric-driven transmission 22 is similarly in a neutral state such that the transmission provides no rotation or drive to the traction wheel 16a attached thereto. As a control lever 20 is rotated forwardly of the neutral position, the forward movement of the control lever 20 is transferred via the linkage assembly 24 to the corresponding hydrostatic or electric-driven transmission 22 to cause the transmission to generate forward rotation of the traction wheel 16a attached thereto. The greater the angle the control lever 20 is rotated forwardly relative to the neutral position, the greater the rotational speed that the hydrostatic or electric-driven transmission 22 drives the corresponding traction wheel 16a. Similarly, as the control lever 20 is rotated rearwardly of the neutral position, the rearward movement of the control lever 20 is transferred via the linkage assembly 24 to the corresponding hydrostatic or electric-driven transmission 22 to cause the transmission to generate rearward rotation of the traction wheel 16a attached thereto. The more rearward the control lever 20 is rotated relative to the neutral position, the greater the rotational speed that the hydrostatic or electric-driven transmission 22 drives the corresponding traction wheel 16a. While the relative fore/aft position of the control levers 20 relative to the neutral position determines the relative fore/aft speed of the corresponding traction wheel 16a, the overall relative position of the control levers 20 relative to each other—and also relative to the neutral position—determines the direction of travel of the maintenance vehicle, as will explained below. The independently-driven traction wheels 16a provides the maintenance vehicle 10 with zero-turn radius capabilities, particularly when one of the control levers 20 is pushed forward relative to the neutral position and the other control lever 20 is pulled rearward relative to the neutral position.

In other embodiments, the control levers 20 are connected to the hydrostatic or electric-driven transmissions 22 by way of an electrical connector configured to electrically control a solenoid or other component configured to adjust the swashplate of the hydrostatic transmission or to directly electrically control an electric-driven transmission. It should be understood by one having ordinary skill in the art that any connecting assembly—be it electrical, mechanical, or electro-mechanical—can be used to operatively connect the control levers 20 to the transmissions 22.

In an embodiment, each of the first and second sensors 26, 28 is operatively connected to one of the hydrostatic or electric-driven transmission 22 for sensing or measuring at least one characteristic of each transmission. The characteristic of the transmission 22 measured by the first and second sensors 26, 28 includes either the output (such as rotational speed and rotational direction) of the corresponding hydrostatic or electric-driven transmission 22 (FIGS. 2A, 2C, and 3A) or the input (such as position of linkage or relative position of control lever) into the corresponding hydrostatic or electric-driven transmission 22 (FIGS. 2B, 2D, and 3B). In other embodiments, the first and second sensors 26, 28 are configured to measure an input, and output, or both an input and an output of each of the hydrostatic of electric-driven transmissions 22. It should be understood by one having ordinary skill in the art that other characteristics of the hydrostatic or electric-driven transmission 22 can be measured by the first and second sensors 26, 28. In an embodiment, the first and second sensors 26, 28 are configured to measure a characteristic, wherein the characteristic is the mechanical input (or relative position) of a given location on the linkage assembly 24 extending between the control lever 20 and the corresponding hydrostatic or electric-driven transmission 22 by way of the linkage assemblies 24. In another embodiment, the first and second sensors 26, 28 are operatively connected to the control levers 22, and each of the first and second sensors 26, 28 is configured to measure a characteristic, wherein the characteristic is the relative position of the corresponding control lever 22. In other embodiments, the first and second sensors 26, 28 are configured to measure a characteristic, wherein the characteristic is the rotational output of the hydrostatic or electric-driven transmissions 22 by way of the corresponding output shaft 34, 36. In still other embodiments, both the first and second sensors 26, 28 measure a characteristic, wherein one of the sensors measures a characteristics that is the mechanical input into one of the hydrostatic or electric-driven transmissions 22 and the other sensor measures a characteristic that is the rotational output of the other hydrostatic or electric-driven transmission 22 by way of the output shaft corresponding to the other hydrostatic or electric-driven transmission 22. The first and second sensors 26, 28 are operatively connected to the system controller 30, and the first and second sensors 26, 28 are both configured to generate a first output signal in response to the characteristic. The first output signal of each of the first and second sensors 26, 28 is then transmitted to the system controller 30 in response to the characteristic(s) of the corresponding hydrostatic or electric-driven transmission 22.

In yet other embodiments, the control levers 20 are both operatively connected to a single sensor (not shown) that measures a characteristic which is the position of both control levers 20 relative to each other as well as relative to the neutral position of each control lever 20. This single sensor is configured to generate a first output signal that is transmitted to the system controller 30 for indirectly controlling the steered direction of at least one steered wheel assembly 17 as well as both hydrostatic or electric-driven transmissions 22 for directly controlling the rotational speed and rotational direction of the traction wheels 16a.

In the embodiment of the maintenance vehicle 10 shown in FIGS. 2A, 2C and 3A the first and second sensors 26, 28, are configured to sense the rotational speed as well as the fore/aft rotational direction of the output shafts 34, 36 of the hydrostatic or electric-driven transmissions 22. The first and second sensors 26, 28 are operatively connected to the corresponding hydrostatic or electric-driven transmission 22, to the frame 14, or to any other structure that would still allow the first and second sensors 26, 28 to properly operate. The first and second sensors 26, 28 each generate a first output signal in response to sensing the rotational speed and rotational direction of the output shafts 34, 36. The first and second sensors 26, 28 each transmit the first output signal to the system controller 30. The first and second sensors 26, 28 can be formed as a Hall effect sensors, or can be any other sensor (or combination of sensors) that are capable of sensing both the rotational speed of the output shafts 34, 36 as well as the rotational direction of the output shafts 34, 36. Although each of the first and second sensors 26, 28 is described herein as a single sensor, it should be understood by one having ordinary skill in the art that a combination of multiple sensors—one to sense the rotational speed and one to sense the rotational direction of the corresponding output shaft 34, 36, or other characteristic—can be used to sense the output of the corresponding hydrostatic or electric-driven transmission 22.

In another embodiment of the maintenance vehicle 10 shown in FIGS. 2B, 2D, and 3B, the first and second sensors 26, 28 are configured to measure the relative position of the control levers 20. In the illustrated embodiment, the first and second sensors 26, 28 measure the relative position of a specific location of the linkage assembly 24 extending between a control lever 20 and a corresponding hydrostatic or electric-driven transmission 22 to determine the mechanical input from the control levers 20 to the hydrostatic or electric-driven transmissions 22. The linkage assemblies 24 convert the rotational, or fore/aft movement of a corresponding control lever 20 into a translational mechanical input into the hydrostatic or electric-driven transmission 22. The first and second sensors 26, 28 are each configured to sense the linear position of the input from the corresponding linkage assembly 24 and generate a first output signal representing the characteristic, or mechanical input (or relative change of position of the location on the linkage assembly 24), into the hydrostatic or electric-driven transmission 22. In an embodiment, the first and second sensors 26, 28 are configured to sense the input into the corresponding hydrostatic or electric-driven transmission 22 and the first output signals generated by the first and second sensors 26, 28 represent both the intended rotational speed and rotational direction that the corresponding hydrostatic or electric-driven transmission 22 is supposed to produce to drive the traction wheel 16a attached thereto. In another embodiment, the first and second sensors 26, 28 are configured to sense the input position of the linkage assembly 24 into the corresponding hydrostatic or electric-driven transmission 22 to generate a first output signal that is received and utilized by the system controller 30.

In other embodiments, the first and second sensors 26, 28 can be configured to measure the relative position of the swashplate (not shown) of the hydrostatic or actuator of the electric-driven transmissions 22. In still further embodiments, the first and second sensors 26, 28 can be operatively connected to the control levers 20 for measuring or sensing the relative position of each lever during operation of the maintenance vehicle 10. It should be understood by one having ordinary skill in the art that the first and second sensors 26, 28 can be positioned at any location on the maintenance vehicle 10 and be configured to measure or sense any characteristic that is either the input or output of the transmissions 22 used to determine both the rotational speed and rotational direction of each of the traction wheels 16a.

The left and right hydrostatic or electric-driven transmissions 22 of the maintenance vehicle 10 are configured to be directly controlled by a corresponding control lever 20, and either the input into the hydrostatic or electric-driven transmissions 22 or the output from the hydrostatic or electric-driven transmissions 22 is measured by the first and second sensors 26, 28 to generate a first output signal that is received by the system controller 30. The system controller 30 is configured to receive the first output signals generated by the first and second sensors 26, 28, and the system controller 30 then transmits at least one second output signal to a steering controller 32 for indirectly controlling the steering of the steered wheel assembly/assemblies 17. The steered wheel(s) 16b is indirectly controlled because the signal for controlling the relative steered direction of the steered wheel assembly/assemblies 17 is a result of the characteristic input or output of the hydrostatic or electric-driven transmissions 22. In other words, the hydrostatic or electric-driven transmissions 22 are directly driven by the control levers, and the steered wheel(s) 16b are indirectly driven such that the direction of the steered wheel(s) 16b is in response to a calculated value or position which utilizes the characteristic of the input or output of those same hydrostatic or electric-driven transmissions 22. In an embodiment, the system controller 30 is configured to receive the first output signal from each of the first and second sensors 26, 28, and the system controller 30 compares the data provided by the first output signals to determine the overall steered direction of the maintenance vehicle 10. The controller 30 then generates a second output signal that causes the steered wheel assembly/assemblies 17 to be steered in the overall steered direction as determined by the characteristic of the traction wheels 16a. In other embodiments, the system controller 30 receives the output signal from both of the hydrostatic or electric-driven transmissions 22 and utilizes a look-up table to determine the steered direction of the maintenance vehicle 10 and generates a second output signal for steering the steered wheel assembly/assemblies 17 in substantially the same direction. In some embodiments, the calculation of the speed of rotation as well as the direction of rotation of each output shaft 34, 36 is performed by the system controller 30, but can alternatively be performed by the first and second sensors 26, 28. In other embodiments, the speed of rotation and/or the direction of rotation of the output shafts 34, 36 of the hydrostatic or electric-driven transmissions 22 are not calculated by either the first or second sensors 26, 28 or by the system controller 30, yet the overall steered direction of the maintenance vehicle 10 is determined by the rotation of the traction wheels 16a and calculated by the system controller 30.

The system controller 30 is configured to receive the first output signal from each of the first and second sensors 26, 28 relating to the characteristic, which can include the measured rotational speed and rotational direction of the traction wheels 16a. The system controller 30 then generates a second output signal to either a steering controller 32 or a driver 38 that causes the steered wheel assembly/assemblies 17 to be steered in the overall steered direction of the maintenance vehicle 10. In an embodiment, the second output signal from the system controller 30 is electrically transmitted to the steering controller 32 by a wired connection. In another embodiment, the second output signal from the system controller 30 is wirelessly transmitted to the steering controller 32 (not shown). In other embodiments, the system controller 30 generates a plurality of second output signals, wherein each second output signal is transmitted to a separate steering controller 32.

As shown in FIGS. 2A and 3A, the system controller 30 is operatively connected to at least one steering controller 32 that is operatively connected to, or integrally formed with, a driver 38 that is configured to rotate the steered wheel assembly/assemblies 17 operatively connected thereto. In an embodiment, the system controller 30 transmits a second output signal directly to the steering controller 32. In this embodiment, the system controller 30 receives the first output signals from the first and second sensors 26, 28 and generates the second output signal that is transmitted to the driver(s) 38 which cause the driver(s) to steer the steered wheel assembly/assemblies 17 in the direction of travel of the maintenance vehicle 10 in response to the determined direction based upon the characteristics measured by the first and second sensors 26, 28.

As shown in FIGS. 2B and 3B, the system controller 30 is operatively connected to a steering controller 32, and the steering controller 32 is then operatively connected to at least one driver 38 that is configured to rotate the steered wheel assembly/assemblies 17 operatively connected thereto. The steering controller 32 is configured to operatively control each driver 38, wherein the steering controller 32 causes each driver 38 to rotate the steered wheel assembly 17 operatively connected thereto in response to the second output signal received from the system controller 30. In this embodiment, the system controller 30 receives the first output signals from the first and second sensors 26, 28 and generates the second output signal that is transmitted to the steering controller 32, wherein the first output signal includes data relating to the speed and steered direction of the maintenance vehicle calculated by the system controller 30. The steering controller 32 is configured to receive the second output signal from the system controller 30 and calculates the relative rotation of each steered wheel assembly 17 necessary to achieve substantially the same steered direction produced by the traction wheels 16a. The second output signal from the steering controller 32 then prompts the driver 38 to rotate the steered wheel assembly 17 attached thereto.

As shown in FIGS. 2C-2D, the system controller 30 is operatively connected to the steering controller 32 which includes an integrated actuator 42 that is configured to rotate the steered wheel assemblies 17 operatively connected thereto, wherein the system controller 30 transmits a second output signal directly to the steering controller 32. In an embodiment, the steering controller 32 is configured to receive the second output signal generated by the system controller 30, and the steering controller 32 then causes the actuator 42 to steer the steered wheel assemblies 17 in the overall steered direction of the maintenance vehicle 10.

In the embodiments illustrated in FIGS. 2A-2B, each of the drivers connected to the steering controller 32 is operatively connected to a steered wheel assembly 17. In FIGS. 2C-2D, the actuator 42 is operatively connected to a tie rod 40, wherein a steered wheel assembly 17 is operatively connected to each opposing end of the tie rod 40. In the embodiment illustrated in FIGS. 3A-3B, the driver 38 is operatively connected to a single steered wheel assembly 17. The drivers 38 are configured to turn, or otherwise rotate, the steered wheel assembly 17 in order to steer the steered wheel(s) 16b in the direction of travel in response to the calculated rotational speed and rotational direction of the traction wheels 16a or the calculated steered direction of the maintenance vehicle 10 based upon the characteristic measured by the first and second sensors 26, 28.

In an embodiment, the drivers 38 are formed as servomotors, but it should be understood by one having ordinary skill in the art that the drivers 38 can be formed of any mechanism capable of receiving the second output signal from the system controller 38 and rotating a steered wheel assembly 17 operatively connected thereto in response to the second output signal from the system controller 30.

In the embodiments shown in FIGS. 2C-2D, the steering controller 32 includes an actuator 42 and a tie rod 40, wherein the tie rod 40 is movable in a generally axial manner by the actuator 42. A steered wheel assembly 17 is attached to each opposing distal end of the tie rod 40, and the tie rod 40 is configured to simultaneously control the rotation of the steered wheel assemblies 17. The actuator 42 is controlled by the steering controller 32 and is configured to move the tie rod 40 laterally, thereby causing rotation of both steered wheel assemblies 17. In an embodiment, each end of the tie rod 40 is directly connected to the kingpin 44 of the steered wheel assemblies 17. In another embodiment, each end of the tie rod 40 is indirectly connected to the kingpin 44 of the steered wheel assemblies 17, wherein each end of the tie rod 40 is attached to a bell crank (not shown) which is configured to drive a corresponding bell crank attached to the kingpin 44. Lateral movement of the tie rod 40 causes the mating bell cranks to rotate, which causes the kingpin 44 to similarly rotate thereby resulting in the rotation of the steered wheels 16b. The bell cranks allows for over-center steering of the steered wheels 16b. In an embodiment, the actuator 42 includes a motor (not shown) and a pinion gear (not shown) that meshes with a corresponding rack gear (not shown) formed on the tie rod 40 to form a rack-and-pinion steering mechanism between the actuator 42 and the tie rod 40. In other embodiments, the actuator 42 can be formed as any mechanism that causes the tie rod 40 to move substantially laterally to steer the steered wheel assemblies 17, including a sector gear (not shown) that drives the tie rod 40 laterally or a double-ended cylinder which can have separate tie rods 40 extending therefrom in which each tie rod 40 drives the rotation of a corresponding steered wheel assembly 17.

FIGS. 2A-2D and 3A-3B illustrate electrical connections between the first and second sensors 26, 28 and the system controller 30 and between the system controller 30 and the drivers 38 and the steering controller 32. It should be understood by one having ordinary skill in the art that the output signals from the first and second sensors 26, 28 as well as the output signal from the system controller 30 can also be sent wirelessly, mechanically, or any other method of transmission from the system controller 30 to the steering controller 32 for indirectly controlling the steering of the steered wheels 16b.

FIGS. 2A-2D and 3A-3B illustrate both a first sensor and a second sensor 26, 28 for measuring at least one characteristic of the hydrostatic or electric-driven transmissions 22 (which may include the rotational speed and/or rotational direction of either the input into or output from the transmissions). In some embodiments, only a single sensor is used to measure the relative position of a corresponding control lever 20, and the single sensor then generates a representative first output signal that is transferred to the system controller 30. In other embodiments, each of the first sensor 26 and the second sensor 28 includes multiple sub-sensors, wherein each sub-sensor measures either the rotational speed or the rotational direction of the output shaft 34, 36. The sub-sensors can also measure the position of a corresponding control lever 20 or the position of a particular location on the linkage assembly extending between each control lever and the hydrostatic or electric-driven transmission 22.

FIG. 3A illustrates an embodiment of a maintenance vehicle 10 in which the steered wheel assembly 17 includes only a single steered wheel 16b, and FIG. 3B illustrates an embodiment of a maintenance vehicle 10 in which the steered wheel assembly 17 includes a pair of steered wheels 16b. The steered wheel assembly 17 having a plurality of steered wheels 16b provides more stable contact with the ground at the front end of the vehicle, but the increased contact area between the wheels and the ground increases the friction therebetween which may increase the force necessary to rotate the steered wheel assembly 17.

In the embodiments shown in FIGS. 2A-2D, each steered wheel assembly 17 includes a kingpin 44 operatively connected to a knuckle (not shown) that is attached to the frame 14. The steered wheel assembly 17 also includes a steered wheel 16b that is operatively connected to the kingpin 44 such that rotation of the kingpin 44 results in similar rotation of the steered wheel 16b connected thereto. In the embodiments shown in FIGS. 3A-3B, each steered wheel assembly 17 includes at least one steered wheel 16b that is attached to a generally U-shaped bracket 44. The rotation or steered angle of the U-shaped bracket 44 is determined by the steering controller 32 which controls the driver that rotates the U-shaped bracket 44 and the steered wheel(s) 16b attached thereto.

The steered wheel(s) 16b, as shown in FIGS. 2A-2D and 3A-3B, are steerably controlled by the steering controller 32. Each steered wheel 16b includes a rim (not shown) having a pneumatic tire attached thereto, and the rim is operatively coupled to a kingpin 44. The pneumatic tire provides a flexible, grippable surface for positively contacting the ground during operation. As will be explained below, the positive contact between the steered wheel(s) 16b and the ground as well as the steerability of the steered wheel(s) 16b add stability to the maintenance vehicle 10, particularly on wet surfaces, inclined surfaces, and/or during a turning operation. In other embodiments, the steered wheel(s) 16b are formed as a flexible and/or surface-grippable non-pneumatic tire.

Positioning the steering controller 32 as well as the steered wheel(s) 16b at one end of the maintenance vehicle 10 provides additional weight at that end of the maintenance vehicles to better stabilize the vehicle along the longitudinal axis, particularly on embodiments of the maintenance vehicle 10 in which the engine, motor, or power supply is located at the opposing longitudinal end of the maintenance vehicle 10. Typical zero-turn mowers and other similar machines have at least three-fourths of the weight of the vehicle supported by the traction wheels, and these machines also utilize non-steerable caster wheels. The caster wheels add very little weight to the front end of the vehicle, and the caster wheels are very poor at gripping the ground during turns and/or while the vehicle is driven on a hillside. The steered wheel(s) 16b of the maintenance vehicle 10 provide added positive, contact with the ground. This is particularly helpful when driving the vehicle 10 laterally across inclined surfaces by reducing the likelihood of slippage of that end of the vehicle, which makes the maintenance vehicle 10 more stable and controllable.

In operation, an operator positioned in the seat 12 grasps the control levers 20 and rotates the control levers 20 in the fore/aft direction to control both the speed and direction of the maintenance vehicle 10. When both control levers 20 are rotated forwardly from the neutral position the same amount, the hydrostatic or electric-driven transmissions 22 generate the same forward rotational speed to the traction wheels 16a. Simultaneously, each of the first and second sensors 26, 28 provide a first output signal to the system controller 30, and the system controller 30 transmits a second output signal to the steering controller 32 which operatively controls the steered direction of the steered wheel assembly/assemblies 17 to align the steered wheel(s) 16b to steer a straight-ahead course. If one of the control levers 20 is rotated forwardly more than the other or one of the control levers 20 is pulled rearwardly (after both control levers have previously been rotated forward of the neutral position), then the traction wheels 16a steer the vehicle in the direction of the rearward-most control lever 20. Simultaneously, each of the first and second sensors 26, 28 provide a first output signal to the system controller 30, and the system controller 30 transmits a second output signal to the steering controller 32 to turn the steered wheel(s) 16b of the steered wheel assembly/assemblies 17 at an angle that corresponds to the overall steered direction determined by the traction wheels 16a. The steered wheels 16b are steered in a similar manner when both of the control levers are rotated rearwardly of the neutral position. Similarly, the steered wheels 116b are steered in a manner corresponding to the direction of travel determined by the traction wheels 16a when one of the control levers 20 is pushed forwardly relative to neutral and the other control lever 20 is pulled rearwardly relative to neutral.

When one control lever 20 is rotated forwardly of the neutral position and the other control lever is rotated rearwardly of the neutral position—resulting in a small-radius or zero-radius turn—the first and second sensors 26, 28 measure either the relative position of both control levers 20 being input into the hydrostatic or electric-driven transmissions 22 or the rotational speed and rotational direction of the respective output shaft 34, 36 and generate a first output signal to the system controller 30. The system controller 30 then generates a second output signal to the steering controller 32 to steer the steered wheel(s) 16b by rotating the wheel(s) in the direction of travel that is determined by the relative speed and direction of the traction wheels 16a.

The above description of the various embodiments of the maintenance vehicle 10 illustrate the traction wheels 16a being positioned at the rear of the vehicle and the steered wheels 16b being positioned at the front of the vehicle. However, in other embodiments (not shown), the wheel positions can be reversed such that the traction wheels 16a are positioned at the front end of the vehicle and the steered wheels 16b are positioned at the rear end of the vehicle.

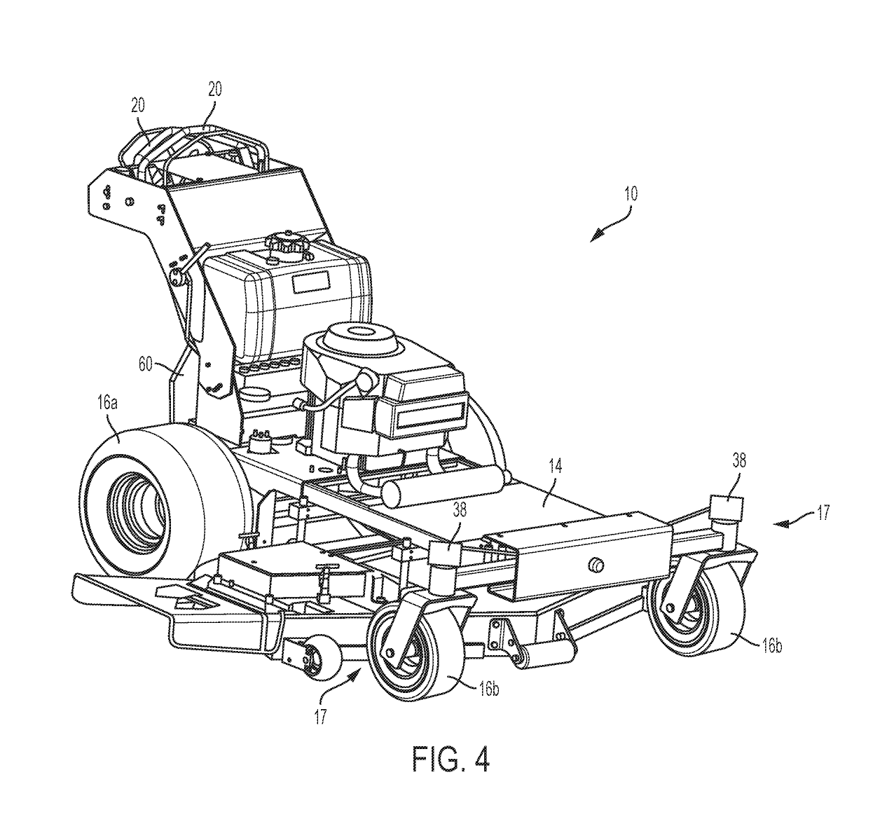

Referring to FIG. 4, another embodiment of a maintenance vehicle 10 is shown. In this embodiment, the maintenance vehicle 10 is shown as a stand-on lawn mower, wherein the maintenance vehicle 10 includes a frame 14, a pair of traction wheels 16a, and a pair of steered wheels 16b which are each part of a steered wheel assembly 17. The maintenance vehicle 10 includes a stand-on platform 60, which is configured to fold down to provide a surface on which an operator can stand during operation of the maintenance vehicle 10. While standing on the platform 60, the operator grasps a pair of control levers 20 that are operatively connected to a pair of hydrostatic or electric-driven transmissions 22 by way of a linkage assembly 18. The traction wheels 16a are positioned adjacent to the rear end of the maintenance vehicle 10, and steered wheel assembly 17 having a steered wheel 16b is positioned adjacent to the front end of the maintenance vehicle 10. Each steered wheel assembly 17 has a driver 38 operatively connected thereto, and each driver 38 is controlled by a steering controller (not shown), as described above. When the stand-on platform 60 is rotated into the stored position, as shown in FIG. 4, the maintenance vehicle 10 is operated as a self-propelled walk-behind mower. It should be understood by one having ordinary skill in the art that the maintenance vehicle 10 can be formed as only a walk-behind mower configured to include control levers 20 that directly control a pair of traction wheels and indirectly steer a pair of steered wheels.

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A maintenance vehicle comprising:
a frame;
a steering mechanism comprising:
a pair of control levers operatively connected to said frame;
a pair of transmissions, wherein each transmission is operatively connected to one of said pair of control levers, each of said transmissions has an output shaft that is connected to a traction wheel, wherein said pair of control levers directly control said transmissions;
a first sensor operatively connected to said steering mechanism, wherein each of said first and second sensors measures a characteristic of said steering mechanism, each of said sensors generating a first output signal representing said characteristic;
a system controller operatively connected to said first and second sensors for receiving said first output signals therefrom, said system controller calculates an overall steered direction and generating at least one second output signal;
at least one steered wheel assembly operatively connected to said frame, each of said at least one steered wheel assembly having at least one steered wheel; and
at least one steering controller operatively connected to said system controller, said at least one steering controller receiving one of said at least one second output signal from said system controller, wherein said steering controller operatively rotates said at least one steered wheel assembly in response to said at least one second output signal from said system controller to steer said at least one steered wheel assembly to said overall steered direction.

2. The maintenance vehicle of claim 1, wherein said characteristic measured by each of said first and second sensors is a mechanical input into each of said pair of transmissions generated by a linkage assembly extending between one of said control levers and one of said transmissions.

3. The maintenance vehicle of claim 1, wherein said characteristic measured by each of said first and second sensors includes both a rotational speed and a rotational direction of said output shaft extending between one of said transmissions and one of said traction wheels attached thereto.

4. The maintenance vehicle of claim 1, wherein said characteristic measured by each of said first and second sensors is a relative position of each of said control levers.

5. The maintenance vehicle of claim 1, wherein said at least one steered wheel of said steered wheel assembly includes only one steered wheel.

6. The maintenance vehicle of claim 1, wherein said at least one steered wheel of said steered wheel assembly includes two steered wheels.

7. The maintenance vehicle of claim 1 further comprising a driver operatively connected to said steering controller and said steered wheel assembly, wherein said driver being controlled by said steering controller for rotating said steered wheel assembly in response to said second output signal received by said steering controller.

8. The maintenance vehicle of claim 7, wherein said at least one driver includes a motor attached to said steered wheel assembly for steering said at least one steered wheel.

9. The maintenance vehicle of claim 7, wherein one steered wheel assembly is attached to each end of a tie rod having a rack gear formed thereon, and said steering controller is operatively connected to an actuator that includes a pinion gear that is meshingly engaged with said rack gear of said tie rod, wherein said tie rod is laterally translatable by said actuator in response to said at least one second output signal from said system controller.

10. The maintenance vehicle of claim 1, wherein each of said pair of transmissions is a hydrostatic transmission or an electric-driven transmission.

11. A maintenance vehicle comprising:
a frame;
a steering mechanism comprising:
a pair of control levers operatively connected to said frame;
a pair of transmissions, wherein each transmission is operatively connected to one of said pair of control levers, each of said transmissions having an output shaft that is connected to a traction wheel, wherein each control lever controls operation of one of said transmissions;
a pair of sensors, wherein each of said sensors measures a characteristic of one of said transmissions, each of said sensors generates a first output signal representing said measured characteristic;
a system controller operatively connected to said sensors for receiving said first output signals therefrom, said system controller determining an overall steered direction determined by said first output signals, and a second output signal being generated by said system controller;
a steering controller operatively connected to said system controller for receiving said second output signal therefrom;
at least one steered wheel assembly operatively connected to said steering controller, each of said steered wheel assemblies including at least one steered wheel, and said steering controller causes rotation of said at least one steered wheel assembly to align each of said at least one steered wheel attached thereto in said overall steered direction in response to said second output signal received from said system controller.

12. The maintenance vehicle of claim 11, wherein each of said pair of transmissions is a hydrostatic transmission or an electric-driven transmission.

13. A method for steering a maintenance vehicle comprising:
providing a steering assembly having a pair of control levers operatively connected to a pair of transmissions, wherein each transmission has an output shaft extending therefrom to which a traction wheel is attached, and movement of each of said control levers controls said corresponding transmission;
measuring a characteristic of each of said transmissions;
providing a system controller for calculating an overall steered direction based upon said measured characteristic of each of said transmissions;
generating an output signal from said system controller; and
steering at least one steered wheel in said overall steered direction in response to said output signal from said system controller.

14. The method of claim 12, wherein said measured characteristic of each of said transmissions is an input into said transmission or an output from said transmission.

15. The method of claim 14, wherein said input into said transmission is a linear displacement of a linkage assembly extending between one of said control levers and one of said transmissions.

16. The method of claim 15, wherein said output from said transmission is both a rational speed and a rotational direction of said output shaft of said transmission.

17. The method of claim 11, wherein each of said pair of transmissions is a hydrostatic transmission or an electric-driven transmission.
